(19) United States
(12) Patent Application Publication
(10) Pub. No.: US 2023/0328870 A1
(43) Pub. Date: Oct. 12, 2023

(54) METHOD FOR PRODUCING A COATING, AND COATING

(71) Applicant: Forschungszentrum Jülich GmbH, Jülich (DE)

(72) Inventors: Emine BAKAN, Jülich (DE); Markus WOLF, Attendorn (DE); Georg MAUER, Tonisvorst (DE); Daniel MACK, Koln (DE); Robert VASSEN, Herzogenrath (DE)

(21) Appl. No.: 18/024,220

(22) PCT Filed: Aug. 31, 2021
(86) PCT No.: PCT/EP2021/074036

§ 371 Date: Mar. 1, 2023

(30) Foreign Application Priority Data
Oct. 6, 2020 (DE) 10 2020 126 082.2

(51) Int. Cl. H05H 1/34; C23C 4/134; C23C 4/04

(52) U.S. Cl. CPC H05H 1/34; C23C 4/134; C23C 4/04; H05H 2245/40

(57) ABSTRACT

The invention relates to a method for producing a coating in which: a substrate is provided; and the substrate is provided with a coating, in particular by means of atmospheric plasma spraying, with a plasma torch having a torch nozzle being used, by means of which torch a plasma jet is generated from a supplied process gas, and with a supplied spraying material being applied to the substrate by means of the plasma jet in order to obtain the coating, wherein the torch nozzle is characterized by a nozzle diameter or a minimum nozzle diameter in the range of 4 mm to 8 mm, in particular 5 mm to 8 mm, preferably 5 mm to 7 mm, and wherein the process gas stream is at least 40 slpm. The invention further relates to a component comprising a substrate and a coating.

### FIELD OF THE INVENTION

The invention relates to a method for producing a coating in which
a substrate is provided,
the substrate is provided with a coating by, in particular, atmospheric plasma spraying, wherein a plasma torch with a torch nozzle is used, with which a plasma jet is generated from a supplied process gas, and wherein a supplied spraying material is applied to the substrate with the plasma jet in order to obtain the coating.

### BACKGROUND OF THE INVENTION

In principle, it is known from the prior art to provide materials with so-called thermal and/or environmental barrier coatings. These are also referred to as thermal barrier coatings (TBC), environmental barrier coatings (EBC) and thermal/environmental barrier coatings (T/EBC). The coatings usually consist of ceramic materials. They in particular have the task of protecting the respective substrate material against temperatures, corrosion and/or oxidation.

Substrates made of silicon-containing materials, for example, are provided with such coatings. EP 1 142 850 A1, for example, discloses a T/EBC for such. It is described that the coatings can be deposited using various previously known methods, wherein Atmospheric Plasma Spraying (APS) and Vacuum Plasma Spraying (VPS), Chemical Vapour Deposition (CVD), High Velocity Oxy Fuel (HVOF) and Physical Vapour Deposition (PVD) are mentioned.

WO 2006/029587 A discloses a method for producing thin, dense ceramic layers by means of APS.

In order to be able to guarantee the required protective performance in the long term, the coatings should be produced with as little stress as possible, free of cracks and, depending on the application, as dense as possible. Due to their high melting points, high process temperatures are required to apply ceramic materials in the molten state to the respective work pieces. Atmospheric Plasma Spraying (APS), Vacuum Plasma Spraying (VPS) and High Velocity Oxygen Fuel (HVOF) are the most widely used thermal coating processes.

In plasma spraying, a plasma jet is used to apply a spray material in the form of particles or suspensions to the surface of a substrate to be coated. A plasma is a hot gas in which the neutral particles are dissociated and ionized. For plasma generation, a so-called plasma torch is used, which comprises a cathode and at least one anode, which are spaced apart to form a narrow gap. An arc is generated between the electrodes by high-frequency ignition. A process gas flows between the electrodes, which may be argon, helium, hydrogen or nitrogen, or mixtures of two or more of these gases. With an appropriately selected process gas supply, a plasma jet is formed, in particular several centimetres long, which emerges from the nozzle of the plasma torch bundled and at high speed. The spray material is injected into the plasma jet in powder form or as a suspension. It is melted due to the high plasma temperatures, carried along with the plasma jet and thrown onto the substrate to be coated.

The adjustment of the process parameters of the spraying process is of decisive importance with regard to the quality and efficiency of the coating produced.

Plasma spraying, including the APS process, produces dense coatings, but usually also coatings that are riddled with cracks, which can lead to premature failure or a reduced protective effect. Another disadvantage is that the coatings produced by the APS process are often amorphous and recrystallize during use. This leads to stresses in the layers due to volume changes, which can also cause premature failure of the layers, or to the formation of coarse cracks, which massively reduces the protective effect, especially for use as EBC. Furthermore, high process temperatures lead to partial evaporation of the coating material and thus often to the formation of foreign phases in the applied coatings that are difficult to control.

Alternative thermal coating processes, such as High Velocity Oxygen Fuel Spraying (HVOF), have the disadvantage that they cause increased coating costs due to high investment, maintenance and utilization costs.

### SUMMARY OF THE INVENTION

Based on the state of the art, it is an object of the present invention to provide a method for producing in particular ceramic coatings with optimized properties compared to the state of the art, which can be carried out with comparatively little effort and, in particular, comparatively cost-efficiently.

In method of the type mentioned above this object is solved in that the burner nozzle is characterized by a nozzle diameter or a minimum nozzle diameter in the range from 4 mm to 8 mm, in particular 5 mm to 8 mm, preferably 5 mm to 7 mm, and in that the process gas flow is at least 40 slpm. Slpm stands here in a manner known per se for standard liters per minute.

It has tuned out that by reducing the nozzle diameter of the plasma torch (which can also be referred to as a plasma generator)—compared with the nozzle diameters of conventional plasma spray coating systems—and increasing the process gas flow rate, it is possible to produce largely dense, crystalline and low-crack coatings by means of plasma spraying. These properties of the coatings are made possible in particular by the fact that the particles used are only partially melted due to the high gas velocities and relatively short dwell time in the plasma torch and still have crystalline components when they hit the substrate. Due to the high velocities achieved in the method according to the invention, one can also speak of high velocity plasma spraying or HV-APS. The high degree of crystallinity of the coatings leads to low recrystallization in the hot application environment and thus to reduced stresses and less cracking. Furthermore, the high kinetic energy of the particles causes the impinging particles to produce a compacted layer.

In particular, the torch nozzle forms that final region, in other words end region of the plasma torch, from which the plasma jet emerges during operation and which is correspondingly turned towards or facing the substrate to be coated. It can be formed by the anode of the plasma torch or, in the case of several anodes, by the anodes of the plasma torch or a section thereof, in particular on the outlet side. The nozzle can also be a component or element separate from the anode(s), which is then expediently arranged (directly) downstream of the anode(s). The nozzle is preferably at least substantially annular and defines a flow channel or flow channel section. The nozzle usually defines an outlet-side end section of a flow channel defined by the plasma torch as a whole.

The nozzle diameter is to be understood as the inner diameter of the nozzle. In particular, the diameter of the flow channel or flow channel section defined by the nozzle.

It is possible that the torch nozzle is characterized by a nozzle diameter that remains constant over its extension in the direction of the gas or plasma flow (flow direction). For example, it can be a cylindrical nozzle or a nozzle with a cylindrical flow chamber (section). In this case, the nozzle diameter is constant over the nozzle extension and the constant nozzle diameter, which is the same everywhere, lies in the aforementioned ranges according to the invention.

Alternatively, the nozzle diameter can also change. In the case of a changing nozzle diameter, the minimum nozzle diameter should be taken into account, which then lies in the above-mentioned range according to the invention. The nozzle diameter can, for example, increase in the direction of the outlet-side end of the nozzle. Then the minimum nozzle diameter would be present at the nozzle inlet and the maximum nozzle diameter at the nozzle outlet. Of course, the diameter can also first decrease over the nozzle expansion and then increase again, so that the minimum nozzle diameter would be present at a position between the nozzle inlet and the nozzle outlet. A conical taper in the direction of the nozzle outlet would also be conceivable. Then the nozzle would have its maximum diameter at the inlet and its minimum diameter at the outlet.

Preferably, crystalline or semicrystalline or largely crystalline coatings are produced by carrying out the method according to the invention. By largely crystalline is meant in particular that coatings are produced which are at least 50% crystalline, preferably at least 60% crystalline, particularly preferably at least 80% crystalline. The percentage values refer in particular to the mass fraction.

By using the method according to the invention, for example, particularly dense and/or semicrystalline silicon, silicate, aluminate, hafnate layers or perovskite layers or mixtures thereof can be produced as the coating or as part of the coating. Coatings obtained in the manner of the invention have improved microstructures, which ensure an improved protective effect as well as a longer service life of the coatings in comparison with coatings sprayed with conventional PS, in particular APS. In this context, the method according to the invention is very economical, in particular significantly more profitable than methods using the HVOF process. By particularly dense, we mean in particular coatings characterized by a porosity of no more than 15%, preferably no more than 10%, particularly preferably no more than 5%.

It has proven particularly suitable if atmospheric plasma spraying (APS) is used in the method according to the invention. This also because atmospheric plasma spraying is associated with particularly low costs in comparison. However, it is also possible to carry out the plasma spraying under reduced pressure, i.e. under vacuum, i.e. to use VPS.

Furthermore, the method according to the invention has proven to be particularly advantageous for obtaining coatings which, when produced by plasma spraying under conventional process parameters, tend to be deposited amorphously and which should or must be particularly dense for a given application, in particular should or must have a porosity of at most 15%, preferably at most 10%, particularly preferably at most 5%. The method according to the invention makes this possible.

The process gas flow expediently is the process gas flow through the burner nozzle.

A preferred embodiment of the method according to the invention is characterized in that the process gas flow is at least 50 slpm, in particular at least 60 slpm, preferably at least 70 slpm, more preferably at least 100 slpm, very particularly preferably at least 150 slpm. In other words, a process gas flow of a value in the mentioned range is set. An upper limit of the process gas flow can be, for example, 400 slpm or even 500 slpm. It has been found to be particularly economical if the process gas flow is at most 200 slpm.

Values in this range have proven to be particularly suitable in the method according to the invention. A particularly high gas velocity and particularly low dwell time in the plasma torch are achieved. As a result, particularly dense coatings can be obtained, which are characterized by a high degree of crystallinity.

The nozzle diameter and the process gas flow are preferably selected such that a gas velocity of at least 1250 m/s, in particular in the range of 1250 m/s to 2500 m/s, is obtained in the torch nozzle. It applies in particular that such a velocity is achieved at least in the range of the minimum nozzle diameter. In particular, in the case where the nozzle diameter is constant, this can of course also apply over the entire nozzle extension.

Conventional means known in principle from the prior art can be used to obtain process gas flows in the ranges mentioned. For example, at least one pressurized gas container can be used in combination with a mass flow controller.

Argon, helium, hydrogen or nitrogen have proven particularly suitable as process gases. Of course, a mixture of two or more of these gases can also be used as process gas. In this context, the process gas flow is to be understood as the total flow of process gas, even if several process gases are used in mixture.

The method according to the invention can, of course, be used to produce both single-layer and multilayer coatings. Several layers can be deposited on top of each other, as is sufficiently known from conventional manufacturing methods.

It is also possible to produce the coating in a single pass, in other words with only one pass over the area to be coated. In this case, it is preferred that a feed rate of the spray material of at least 50 g/m in be set.

The method according to the invention also permits the production of particularly thick coatings, in particular coatings of at least 100 micrometers, in only one coating pass. Comparatively thick coatings can therefore be obtained with only one pass over the area to be coated, and thus a combination of particularly good protective effect at particularly low cost.

The spray material used can in particular be one which comprises or is given by at least one rare earth silicate, for example Yb2Si2O7. These materials have proven particularly suitable for EBCs. They are characterized, for example, by a matched coefficient of thermal expansion and high chemical compatibility with SiC-based substrates. They are stable at high temperatures and offer increased corrosion resistance to water.

Alternatively or additionally, it can be provided that a spray material is used which comprises or is given by at least one rare earth aluminate, preferably Y3Al5O12 and/or YAlO3 and/or LaMgAl11O19. These materials have also proven particularly suitable for EBCs. They are characterized, for example, by an adapted coefficient of thermal expansion and high chemical compatibility with Al2O3-based substrates as well as substrates based on Ni-based materials, including those with previously applied bonding agent layers of, for example, MCrAlY (M=Ni, Co) and/or Pt-Al and possibly other intermediate layers. They are stable at high temperatures and offer increased corrosion resistance to water.

Particularly suitable spray materials or components of spray materials have proven to be, for example: Si with dopants and/or admixture of Hf, rare earth silicates SE-SiO5, SE-Si2O7 with SE=Yb, Y, La, Gd, Lu, Sc, and/or mixtures/co-dopants thereof, aluminium silicates/mullites SiO2-Al2O3 (mixed series), optionally with SE dopants, SE aluminates with perovskite, garnet, or monocline structure: SE-Al-O3, SE3-Al5-O12, SE4-Al2-O9, with SE see above, Aluminates with Hexa-aluminate structure such as e.g. LaMgAl11O19, LaLiAl11O18.5, (complex) perovskites such as e.g. SrZrO3, BaZrO3, La(Al0.25Mg0.5.Ta0.25)O3, Ba(Mg0.33Ta0.66)O3 or with fracture numbers.

It has proven to be particularly advantageous if a spray material is used which comprises or is given by at least one rare earth hexaaluminate, in particular LaMgAl11O19.

The spray material can comprise only one material or also a mixture of materials. By way of pure example, it may comprise or be given by a mixture of two or more different rare earth silicates and/or two or more different rare earth hexaaluminates. For example, a mixture of one or more rare earth silicates and one or more rare earth hexaaluminates is also conceivable. Spray materials with or made of rare earth silicates have proven particularly suitable, for example, when coatings are to be produced on substrates made of fiber composites, as is often the case in the aerospace sector. Spray materials with or made of rare earth aluminates have proven to be particularly suitable, for example, when coatings are to be produced on substrates with or made of nickel, for example with or from nickel-based superalloys, and/or with or from (fully oxide) ceramic fiber composites based on alumina/aluminosilicate/zirconium dioxide, such as are frequently used in turbine technology. For these materials, in particular, they have a suitably adapted coefficient of thermal expansion.

Even though the method according to the invention has proven to be particularly suitable for obtaining ceramic coatings, it cannot be ruled out that non-ceramic coatings with optimum properties can be obtained with it.

Furthermore, it has proven to be useful if a spray material with a mean particle diameter of at most 80 micrometers, in particular at most 50 micrometers, preferably at most 40 micrometers, particularly preferably at most 30 or at most 25 micrometers, is used. It may also be envisaged, for example, that the spray material is characterized by a mean particle diameter of at least 15 micrometers or at least 10 micrometers or at least 5 micrometers. A mean particle diameter can be determined, for example, in a manner known per se by laser diffraction, in particular with Horiba LA-950 V2.

It has proven particularly suitable to use a spray material with a mean particle diameter of less than 30 micrometers. In particular, a spray material with a mean particle diameter in the range from 15 micrometers to 29 micrometers, preferably 10 micrometers to 29 micrometers, particularly preferably 15 micrometers to 29 micrometers, can be used.

A preferred manufacturing method for a particularly powdered spray material is agglomerated and sintered. Accordingly, the method according to the invention may comprise that the in particularly powdery spray material is first produced, preferably by agglomerating and sintering. Molten or sintered and crushed powders can also be used. Accordingly, the method according to the invention can comprise that the spray material, in particular in powder form, is produced by melting and/or sintering and crushing first.

Layers obtained according to the invention may form a complete protective coating, such as EBC, or, for example, only part of such a coating.

The substrate provided may be uncoated or may already have a (partial) coating. For example, it has been shown to be suitable if a top layer, for example a Yb2Si2O7 top layer for an EBC system, is produced by carrying out the method according to the invention. Then the coating produced according to the invention forms a part of an EBC coating system.

As far as the spray distance between the torch nozzle and the substrate is concerned, it has been found to be particularly suitable if it is in the range of 60 mm to 200 mm, in particular 70 mm to 180 mm, preferably 80 mm to 140 mm. More preferably, it can be 100 mm or 120 mm. Another example of a suitable spray distance is 80 mm.

The current can, for example, be in the range from 300 A to 550 A, in particular in the range from 300 A to 400 A or 400 A to 500 A, preferably amount to 375 A or 450 A or 470 A. The unit symbol A stands for ampere in a sufficiently known manner. The current is expediently the working current used to at least partially ionize the process gas between the cathode and anode(s) of the plasma torch and thus to generate a plasma.

In a further preferred embodiment, the torch velocity is at most 2000 mm/s. In particular, it is in the range from 100 mm/s to 1500 mm/s, preferably from 400 mm/s to 600 mm/s. It particularly preferably amounts to 250 mm/s or 500 mm/s. The torch speed is in particular the relative speed between the plasma torch and the substrate to be coated during the coating process. This is expediently in a lateral direction parallel to the surface of the substrate to be coated. The movement is usually realized by moving the plasma torch relative to the substrate, for example by means of a robot on which the plasma torch is mounted. Then, during the coating process, the plasma torch is moved at a speed in the aforementioned ranges.

For the feed rate of the spray material, in particular in powder form, it has been found to be particularly suitable if it is at least 5 g/min, in particular at least 10 g/min, in other words if it is selected or set accordingly. For example, it can be 10 g/min or 30 g/min or 90 g/min, which has proven to be very suitable. It may further be that the spray material delivery rate is at most 150 g/min.

Conventional means known in principle from the prior art can be used for conveying the spray material. It has proven suitable, for example, if the spray material is conveyed/supplied by means of a conveying gas in the range from 2 bar to 5 bar and using a powder conveyor.

Before and/or during the application of the coating, the substrate is suitably heated. For example, the substrate can be preheated to a temperature of at least 200° C., at least in sections, before the coating is applied.

Alternatively or additionally, the substrate can be heated at least in sections to a temperature of at least 250° C., preferably at least 300° C., during application of the coating. During coating, for example, heating to a temperature in the range of 200° C. to 700° C., preferably 300° C. to 500° C., can take place. In other words, during the application of the coating, the substrate has, at least in sections, a temperature in the range of 200° C. to 700° C., preferably 300° C. to 500° C. For example, the substrate can be heated to 270° C., 400° C. or 500° C. or even 600° C. In other words, the substrate has a temperature in the range from 200° C. to 700° C., preferably 300° C. to 500° C., at least in sections during the application of the coating.

The method according to the invention has proven to be particularly suitable for obtaining coatings on substrates comprising or consisting of silicon, for example silicon carbide and/or silicon nitride. By way of pure example, it may be mentioned that a substrate made of a fiber composite material is coated with a silicon bondcoat.

Of course, other substrates with or made of other materials can also be provided and coated in the manner according to the invention. Substrates with or made of nickel, in particular with or made of a nickel-based superalloy, and/or substrates with or made of alumina-based composites are also possible, for example. Such substrates can of course also have a bondcoat, for example an MCrAlY bondcoat (M=Ni, Co), on which a coating is then produced in accordance with the invention.

Another particularly advantageous embodiment is characterized by the fact that the process gas flow is at least 100 slpm, preferably in the range from 100 slpm to 500 slpm, particularly preferably in the range from 100 slpm to 400 slpm, and that the torch nozzle is characterized by a nozzle diameter or a minimum nozzle diameter in the range from 5 mm to 8 mm, preferably 5 mm to 7 mm, particularly preferably 6 to 7 mm, and that a spray material with an average particle diameter of at most 40 micrometers is used, in particular a spray material with an average particle diameter in the range from 5 micrometers to 40 micrometers, preferably in the range from 10 micrometers to 40 micrometers, particularly preferably in the range from 15 micrometers to 40 micrometers, and in that the substrate is heated during the application of the coating at least in sections to a temperature of at least 300° C., in particular to a temperature in the range from 300° C. to 700° C., preferably in the range from 300° C. to 500° C. With regard to the temperature, in other words, the substrate has a temperature in the range from 200° C. to 700° C., preferably 300° C. to 500° C., at least in sections during the application of the coating.

Alternatively or additionally, it may further be provided that the spray distance between the torch nozzle and the substrate is at least 100 mm, preferably in the range of 100 mm to 200 mm, and that the current is at least 400 A, preferably in the range of 400 A to 550 A. It has been found to be particularly advantageous if these values of spray distance and current are combined with the values for process gas flow, nozzle diameter, particle size and substrate temperature(s) mentioned in the preceding paragraph.

Particularly preferred in combination with the above parameters is a spray material with a mean particle diameter of less than 30 micrometers, in particular a spray material with a mean particle diameter in the range of 15 micrometers to 29 micrometers, preferably 10 micrometers to 29 micrometers, more preferably 15 micrometers to 29 micrometers.

A particularly suitable combination of process parameters for the method according to the invention has proven to be, for example, as shown in Table 1:

TABLE 1

| | |
|---|---|
| Torch nozzle diameter: | 4 mm to 8 mm, |
| | in particular 5 mm to 8 mm, |
| | preferably 5 mm to 7 mm, |
| | particularly preferably 5 mm or |
| | 6.5 mm |
| Average particle diameter | at most 50 micrometers, |
| of the spray material: | preferably at most 30 micrometers |
| | or less than 30 micrometers |
| Spray distance: | 70 mm to 180 mm, |
| | preferably 80 mm to 120 mm, |
| | especially preferred 100 mm |
| Process gas flow: | at least 40 slpm, preferably at least |
| | 50 slpm, particularly preferred 50 slpm |
| Current: | 300 A to 400 A, preferably 350 A to |
| | 390 A, particularly preferably 375 A |
| Torch speed: | at most 2000 mm/s, preferably 100 mm/s |
| | to 1500 mm/s, particularly preferably |
| | 500 mm/s |
| Spray material feed rate: | at least 10 g/min, preferably 30 g/min |
| Substrate temperature: | at least 200° C. during preheating |
| | at least 250° C., preferably 270° C. during |
| | coating |

It has been shown that via this process parameter combination, for example, protective coatings in particular with or of at least one rare earth silicate, preferably Yb2Si2O7, and/or with or of at least one rare earth hexaaluminate, in particular LaMgAl11O19, with low crack density and increased crystallinity can be well obtained.

Another example of a particularly suitable combination of process parameters for the method according to the invention is shown in Table 2:

TABLE 2

| | |
|---|---|
| Torch nozzle diameter: | 4 mm to 8 mm, in particular 5 mm to |
| | 8 mm, preferably 5 mm to 7 mm, |
| | particularly preferably 5 mm or 6.5 mm |
| Average particle diameter | a maximum of 50 micrometers, preferably a |
| of the spray material: | maximum of 40 micrometers or less than |
| | 40 micrometers |
| Spray distance: | 70 mm to 180 mm, |
| | preferably 100 mm to 150 mm, |
| | especially preferred 120 mm |
| Process gas flow: | at least 80 slpm, preferably at least |
| | 100 slpm, particularly preferred 110 slpm |
| Current: | 400 A to 500 A, preferably 420 A to 470 A, |
| | particularly preferably 450 A |
| Torch speed: | a maximum of 2000 mm/s, preferably |
| | 200 mm/s to 1000 mm/s, particularly |
| | preferably 500 mm/s |
| Spray material feed rate: | at least 10 g/min, preferably 30 g/min |
| Substrate temperature: | at least 200° C. during preheatingat least |
| | 300° C., preferably 400° C. during coating |

It has been shown that this combination of process parameters is very suitable, for example, for the production of protective coatings, in particular with or from at least one rare earth silicate, preferably Yb2Si2O7, and/or with or from at least one rare earth hexaaluminate, in particular LaMgAl11O19, with high crystallinity and particularly low impurity phase content.

Another particularly suitable combination of process parameters is shown in Table 3:

TABLE 3

| | |
|---|---|
| Torch nozzle diameter: | 4 mm to 8 mm, in particular 5 mm to |
| | 8 mm, preferably 5 mm to 7 mm, |
| | particularly preferably 5 mm or 6.5 mm |
| Average particle diameter | a maximum of 50 micrometers, preferably a |
| of the spray material: | maximum of 30 micrometers or less than |
| | 30 micrometers |
| Spray distance: | 70 mm to 180 mm, |
| | preferably 100 mm to 150 mm, |
| | especially preferred 120 mm |
| Process gas flow: | at least 80 slpm, preferably at least |
| | 100 slpm, particularly preferred 110 slpm |
| Current: | 400 A to 500 A, preferably 420 A to 470 A, |
| | particularly preferably 450 A |
| Torch speed: | a maximum of 2000 mm/s, preferably 200 |
| | mm/s to 1000 mm/s, particularly preferably |
| | 500 mm/s |
| Spray material feed rate: | at least 10 g/min, preferably 30 g/min |
| Substrate temperature: | at least 200° C. during preheating |
| | at least 300° C., preferably 500° C. during |
| | coating |

As has been shown, this combination is particularly suitable, for example, for the production of protective coatings with low porosity, in particular from a mixture of rare earth silicates and/or with or from at least one rare earth hexaaluminate, in particular LaMgAl11O19, for example SE disilicates and monosilicates, in particular Yb2Si2O7 and Yb2SiO5.

Yet another particularly suitable process parameter combination is shown in Table 4:

TABLE 4

| | |
|---|---|
| Torch nozzle diameter: | 4 mm to 8 mm, |
| | in particular 5 mm to 8 mm, |
| | preferably 5 mm to 7 mm, |
| | particularly preferably 5 mm or 6.5 mm |
| Average particle diameter | a maximum of 50 micrometers, |
| of the spray material: | preferably a maximum of 40 micrometers or |
| | less than 40 micrometers |
| Spray distance: | 80 mm to 140 mm, |
| | preferably 100 mm to 130 mm, |
| | particularly preferred 120 mm |
| Process gas flow: | at least 100 slpm, preferably at least 150 |
| | slpm, particularly preferred 170 to 180 slpm |
| Current: | 400 A to 500 A, preferably 420 A to |
| | 470 A, particularly preferably 450 A |
| Torch speed: | a maximum of 500 mm/s, preferably 150 |
| | mm/s to 350 mm/s, particularly preferably |
| | 250 mm/s |
| Spray material feed rate: | at least 50 g/min, preferably 90 g/min |
| Substrate temperature: | at least 200° C. during preheating, |
| | preferably 300° C., |
| | at least 300° C., preferably 420° C. during |
| | coating |

This combination has proved particularly suitable, for example, for the production of protective coatings, in particular with or from at least one rare earth silicate, preferably Yb2Si2O7, and/or with or from at least one rare earth hexaaluminate, in particular LaMgAl11O19, and in particular with a thickness of at least 100 micrometers by means of only a single coating process.

Yet another particularly suitable process parameter combination is shown in Table 5:

TABLE 5

| | |
|---|---|
| Torch nozzle diameter: | 4 mm to 8 mm, |
| | in particular 5 mm to 8 mm, |
| | preferably 5 mm to 7 mm, |
| | particularly preferably 5 mm or 6.5 mm |
| Average particle diameter | a maximum of 80 micrometers, |
| of the spray material: | preferably a maximum of 30 micrometers or |
| | less than 30 micrometers |
| Spray distance: | 70 mm to 150 mm, |
| | preferably 80 mm |
| Process gas flow: | at least 40 slpm, preferably at least |
| | 50 slpm, particularly preferably 50 slpm AR |
| | and 6 slpm He |
| Current: | 350 A to 550 A, preferably 470 A |
| Torch speed: | a maximum of 2000 mm/s, preferably 150 |
| | mm/s to 350 mm/s, particularly preferred |
| | 250 mm/s |
| Spray material feed rate: | at least 5 g/min, preferably 10 g/min |
| Substrate temperature: | at least 200° C. during preheating |
| | at least 300° C. during coating, preferably |
| | 600° C. during coating |

This combination has proven particularly suitable, for example, for the production of dense, crystalline Y3Al5O12 coatings or coatings with or from at least one rare earth hexaaluminate, in particular LaMgAl11O19, on substrates with or from nickel, in particular with or from Nickel-based superalloys. The process parameter combination can be used, for example, to obtain a Y3Al5O12 top layer of a TBC system to protect a corresponding substrate.

Subject matter of the invention is also a component comprising a substrate and a coating obtained by carrying out the method according to the invention.

With respect to embodiments of the invention, reference is also made to the sub-claims and to the following description of several examples of embodiments with reference to the accompanying drawings.

### BRIEF DESCRIPTION OF THE DRAWINGS

The drawings show:

FIG. 1 a purely schematic block diagram showing the steps of five embodiments of the method according to the invention;

FIG. 2 is a purely schematic, highly simplified sectional view of a plasma torch with torch nozzle, which is used within the scope of the embodiments with the steps according to FIG. 1;

FIG. 3 a micrograph of a coating obtained according to a first embodiment of the method according to the invention;

FIG. 4 an X-ray diffraction pattern of the coating according to FIG. 3;

FIG. 5 a micrograph of a coating obtained with a nozzle diameter of 9 mm;

FIG. 6 X-ray diffraction pattern of the coating according to FIG. 5;

FIG. 7 a micrograph of a coating obtained according to a second embodiment of the method according to the invention;

FIG. 8 an X-ray diffraction pattern of the coating according to FIG. 7;

FIG. 9 a micrograph of a coating obtained according to a third embodiment of the method according to the invention;

FIG. 10 an X-ray diffraction pattern of the coating according to FIG. 9;

FIG. 11 a micrograph of a coating obtained according to a fourth embodiment of the method according to the invention;

FIG. 12 an X-ray diffraction pattern of the coating according to FIG. 11;

FIG. 13 a micrograph of a coating obtained according to a fourth embodiment of the method according to the invention; and

FIG. 14 an X-ray diffraction pattern associated with the coating according to FIG. 13.

### DETAILED DESCRIPTION OF THE PREFERRED EMBODIMENT(S)

In the following, five embodiments of the method for producing a coating according to the invention are described.

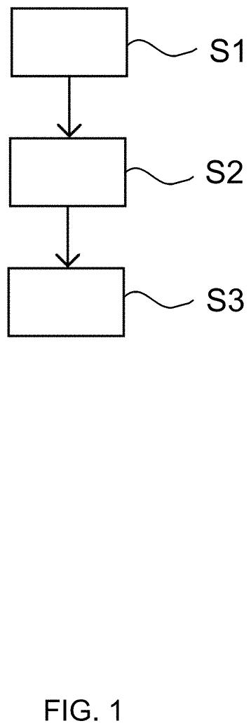

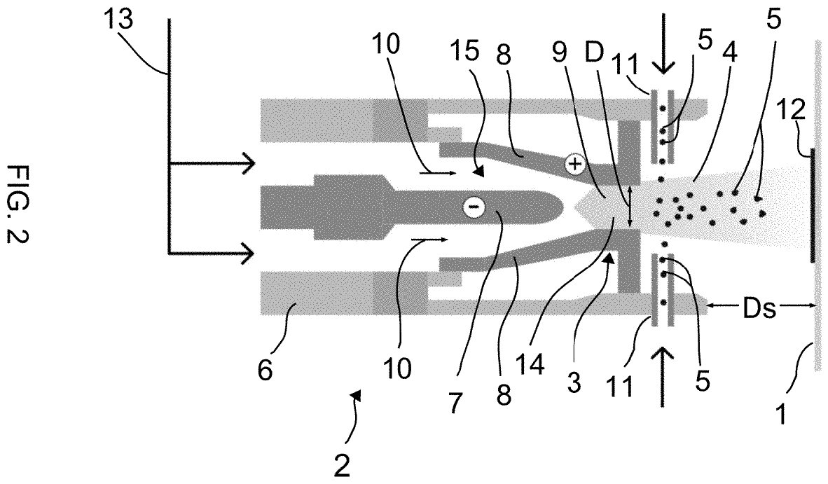

In all examples, a substrate 1 is provided in a first step S1 (cf. FIG. 1). In the first to fourth exemplary embodiments, the substrate 1 is a substrate 1 with silicon, specifically a substrate 1 made of a fiber composite material with a silicon bonding agent layer (bondcoat), on which the coating is produced in each case. In the fifth exemplary embodiment , on the other hand, a substrate made of a nickel-based material is provided in step S1, in particular a substrate 1 made of a nickel-based superalloy. The substrate 1 is only visible in the purely schematic, highly simplified FIG. 2.

In a step S2, the substrate 1 is preheated in each case.

In a step S3, the substrate 1 is coated in each case by atmospheric plasma spraying (APS). A plasma torch 2 (cf. FIG. 2) with a torch nozzle 3 is used for plasma generation in a manner known per se, with which a plasma jet 4 is generated from a supplied process gas, into which a spray material 5 in powder form is injected.

The plasma torch 2 has a housing 6 in which a cathode 7 and at least one anode 8 are arranged, which are spaced apart to form a narrow gap. In the examples described here, the plasma torch 2 has three anodes 8. In all five embodiment examples, this is the TriplexPro-210 model from Oerlikon Metco, whereby this is to be understood purely as an example.

An arc is generated between the electrodes 7, 8 by high-frequency ignition. During operation, a process gas 10 flows between the electrodes 7, 8, which is indicated in simplified form by arrows in FIG. 2, and a gas discharge 9 takes place. With an appropriately selected process gas supply, the plasma jet 4 is formed, which emerges from the nozzle 3 of the plasma torch 2 bundled and at high velocity. The powdered spray material 5 is injected into the plasma jet 4 from the side, via the spray material feeds 11 oriented orthogonally to the plasma jet 4. It should be noted that the orthogonal spray material feed is to be understood as an example. The powder feed is additionally indicated by arrows in FIG. 2. Due to the high plasma temperatures, the powdered spray material 5 is melted, carried along with the plasma jet 4, and thrown onto the substrate 1 to be coated. As a result, a coating 12 is obtained (step S3).

It should be noted that suitable means 13 are provided for the process gas supply, which are indicated by arrows in the purely schematic FIG. 2. In the described example, these comprise at least one compressed gas cylinder and a mass flow controller.

As can be seen, the torch nozzle 3 forms the final area, in other words the end area of the plasma torch 2, from which the plasma jet 4 emerges during operation and which is correspondingly turned towards the substrate 12 to be coated or is turned towards during operation. The nozzle 3 can be formed by the anode 8 of the plasma torch 2 or, in the case of several anodes 8, by the anodes 8 of the plasma torch 2 or a section thereof, in particular on the outlet side. The nozzle 3 can also be a separate element from the anode(s) 8, which is arranged (directly) downstream of the anodes. This is the case in the example shown in FIG. 2. The nozzle 3 is given here by an annular element defining a flow channel 14. The flow channel 14 defined by the nozzle 3 forms the outlet end section 14 of the torch flow channel 15 defined by the plasma torch 2 as a whole.

In accordance with the invention, the torch nozzle 3 is characterized by a nozzle diameter D in the range from 4 mm to 8 mm, in particular 5 mm to 8 mm, preferably 5 mm to 7 mm. In all four examples, the nozzle diameter D of the burner nozzle 3 is 6.5 mm. The nozzle diameter D is, as can be seen, the diameter of the flow channel 14 defined by the nozzle 3. It should be noted that the nozzle 3 defines a cylindrical flow channel 14 and thus has an internal diameter D which remains constant over its entire extent in the gas/plasma flow direction. The nozzle diameter D is therefore 6.5 mm everywhere. This is not necessarily the case. Alternatively, nozzles with a variable nozzle diameter can also be used. In this case, the minimum nozzle diameter lies within the ranges mentioned.

In all embodiments, a process gas flow of at least 40 slpm is also set in accordance with the invention.

The process parameters selected in each of the five embodiment examples and the layers 12 produced are discussed in more detail below.

Example 1:

According to exemplary embodiment 1, a protective coating 12 with low crack density and increased crystallinity is produced.

The spray material 5 used is a rare earth silicate, here Yb2Si2O7, in powder form. It is also possible, for example, to use a spray material 5 comprising at least one rare earth hexaaluminate, in particular LaMgAl11O19, or provided thereby. A preferred method of producing the powder 5, which has been used in the present case, is agglomerated and sintered. The powder 5 has an average particle diameter of below 50 micrometers, below 30 micrometers has proven to be particularly suitable. In the present case, this is 20 micrometers.

Furthermore, a spraying distance Ds (cf. FIG. 2) in the range of 70 mm to 180 mm is selected, in this case 100 mm.

The process gas flow is set to a total flow of at least 40 slpm, in particular at least 50 slpm. In the present case, 50 slpm is selected. Argon is used as the process gas 10 in this example.

The current is in the range from 300 A to 400 A, and amounts to 375 A in this example.

The torch speed is selected to be a maximum of 2000 mm/s, and amounts to 500 mm/s in this example.

The feed rate of the spray material 5 is selected to be at least 10 g/min, is specifically 30 g/min here.

During preheating in step S2, the substrate 1 is brought to a temperature of at least 200° C., in this case to approx. 300° C.

During the actual coating process in step S3, the substrate 1 is heated to at least 250° C., in the exemplary embodiment described here to approx. 270° C.

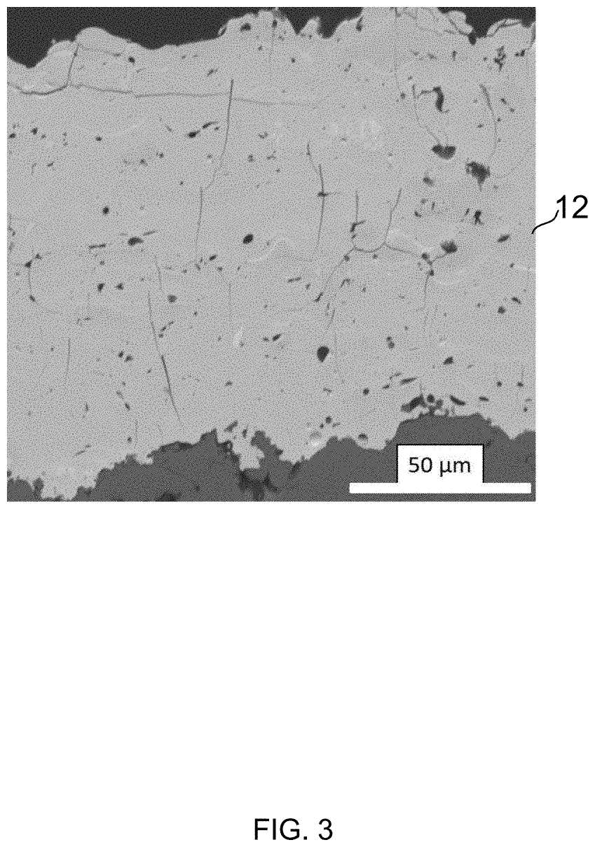

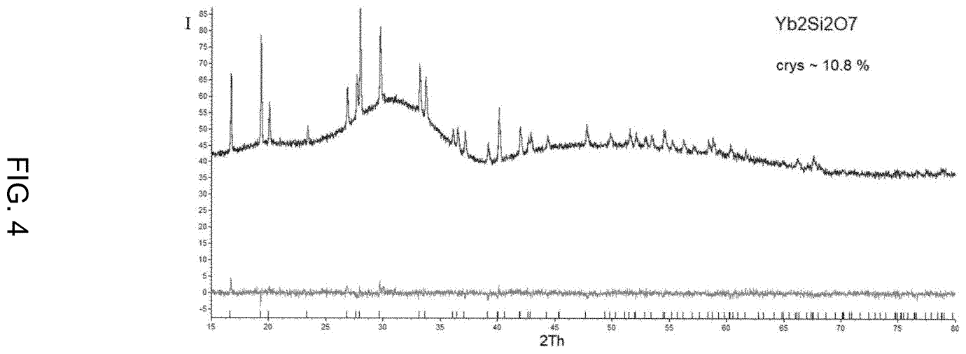

FIG. 3 shows a micrograph of the resulting coating 12 of Yb2Si2O7 produced on the substrate 1 given by a fiber composite with the silicon bondcoat. The coating has a homogeneous microstructure with high density and very fine pores. Only short, unconnected cracks occur. An X-ray diffractogram measurement (XRD measurement, cf. FIG. 4) shows an increased degree of crystallinity of 10% after a Rietveld redefinition. The degree of crystallinity is abbreviated as crys in the figures. In this and all other X-ray diffractograms, the 2Theta angle is plotted on the X-axis and the intensity, specifically the root of the counts, is plotted on the Y-axis. The 2Theta angle is, in a known way, the angle at which the intensity of the diffracted X-rays is measured with respect to the angle of incidence (in Bragg arrangement angle of incidence=angle of reflection).

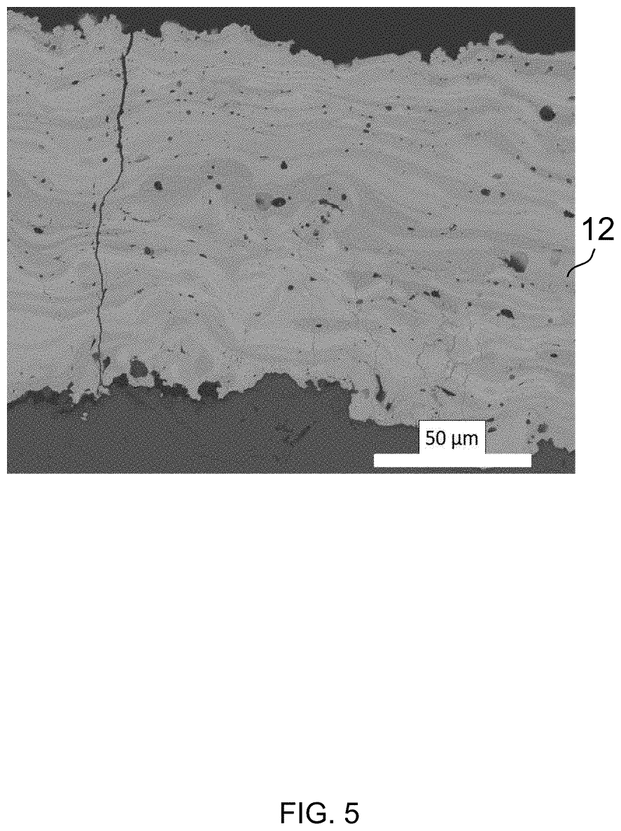

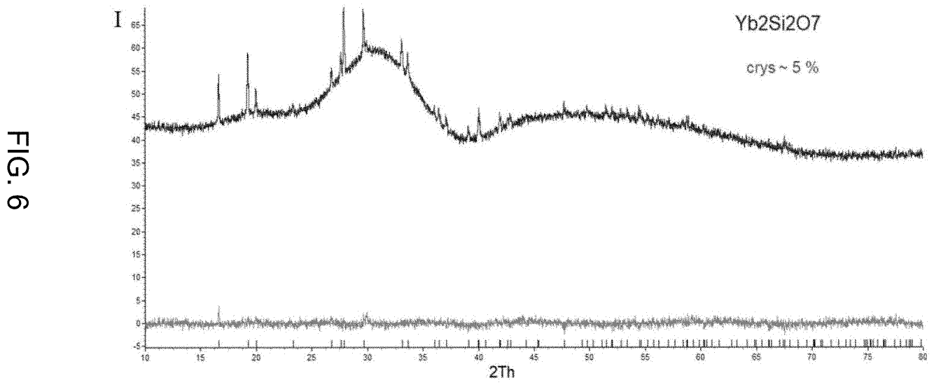

For comparison, FIG. 5 shows the microstructure of a coating with a coarse crack produced by means of APS and a nozzle diameter of 9 mm, also in a micrograph. FIG. 6 shows a corresponding X-ray diffractogram with a recognizable predominantly amorphous component. Here, the current was 450 A, the process gas flow 50 slpm argon, the spray distance Ds 80 mm and the torch speed 500 mm/s.

Example 2:

According to the second embodiment, a protective coating 12 with high crystallinity and particularly low foreign phase content is produced.

The spray material 5 used is a rare earth silicate, Yb2Si2O7, in powder form. For example, a spray material 5 can also be used which comprises at least one rare earth hexaaluminate, in particular LaMgAl11O19, or is provided thereby. A preferred method of producing the powder 5, which has been used in the present case, is agglomerated and sintered. The powder 5 has an average particle diameter of below 50 micrometers, below 40 micrometers has proven to be particularly suitable. In the present case, this is 30 micrometers.

A spraying distance Ds in the range from 70 mm to 180 mm is also selected, in this case 120 mm.

The process gas flow is set to a total flow of at least 80 slpm, in particular at least 100 slpm. In the present case, 110 slpm is selected. Argon is used as the process gas 10.

The current is in the range from 400 A to 500 A, and amounts to 450 A in the present case.

The burner speed is set to a maximum of 2000 mm/s, in this case 500 mm/s.

The feed rate of the spray material 5 is selected to be at least 10 g/min, is specifically 30 g/min here.

During preheating in step S2, the substrate 1 is brought to a temperature of at least 200° C., in this case to approx. 300° C.

During the actual coating process in step S3, the substrate 1 is heated to at least 300° C., in the embodiment example described here to about 400° C.

A special feature of this example is that this layer 12 can be produced with a particularly low proportion of secondary phase Yb2Si2O7.

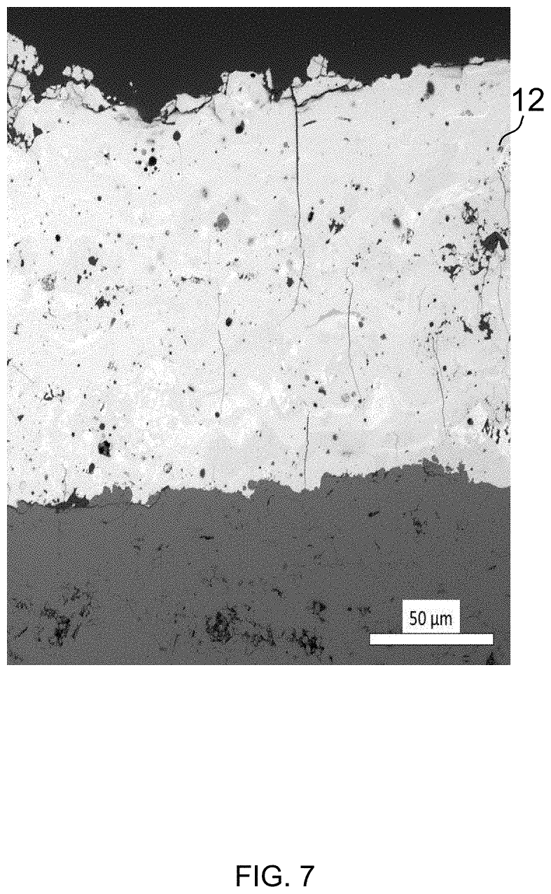

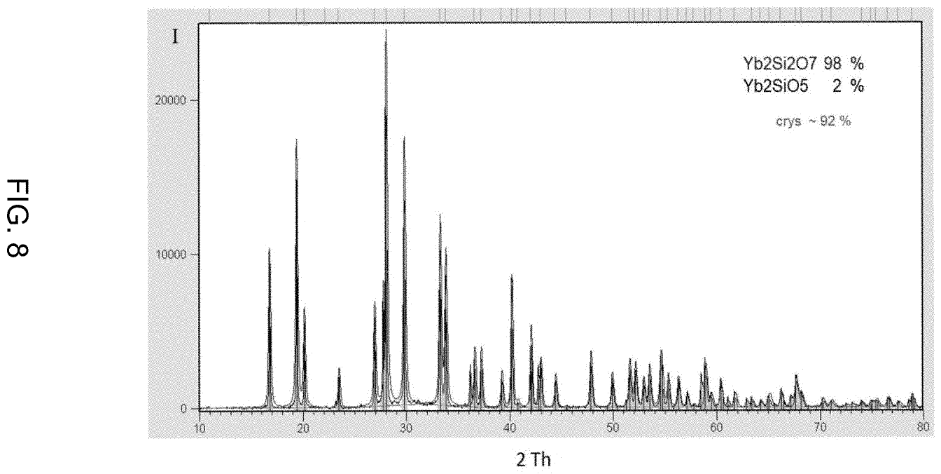

FIG. 7 shows the resulting coating of Yb2Si2O7 produced on the substrate 1 given by a fiber composite with the silicon bondcoat. The coating has a homogeneous microstructure with high density and very fine pores. Only short, unconnected cracks occur. An XRD measurement (cf. FIG. 8) shows an increased degree of crystallinity of 92% after a Rietveld redefinition. As crystalline-line phases 98% Yb2Si2O7 and 2% Yb2SiO5 were determined.

Example 3:

According to the third embodiment, a protective coating 12 with low porosity is prepared from a mixture of fine Yb silicate powders.

A mixture of rare earth silicates, preferably SE disilicates and monosilicates in powder form, is used as the spray material 5. Preferably, a mixture of Yb2Si2O7 and Yb2SiO5 is used. Here, a mixture of 75% Yb2Si2O7 and 25% Yb2SiO5 is used, although this is to be understood as exemplary. For example, a spray material 5 can also be used which comprises or is given by at least one rare earth hexaaluminate, in particular LaMgAl11O19.

The powder 5 has an average particle diameter of below 50 micrometers, below 30 micrometers has proven to be particularly suitable. Presently, this is 20 micrometers. A preferred method of producing the powder 5 is agglomeration and sintering.

Furthermore, an injection distance Ds in the range from 70 mm to 180 mm is selected, in this case 120 mm.

The process gas flow is set to a total flow of at least 80 slpm, in particular at least 100 slpm. In the present case, 110 slpm is selected. Argon is used as the process gas 10.

The current is in the range from 400 A to 500 A, and amounts to 450 A in the present case.

The burner speed is set to a maximum of 2000 mm/s, in this case 500 mm/s.

The feed rate of the spray material 5 is selected to be at least 10 g/min, is specifically 30 g/min here.

During preheating in step S2, the substrate 1 is brought to a temperature of at least 200° C., in this case to approx. 300° C.

During the actual coating process in step S3, the substrate 1 is heated to at least 300° C., in the embodiment example described here to about 500° C.

A special feature of this example is that a coating 12 with a particularly low porosity can be produced.

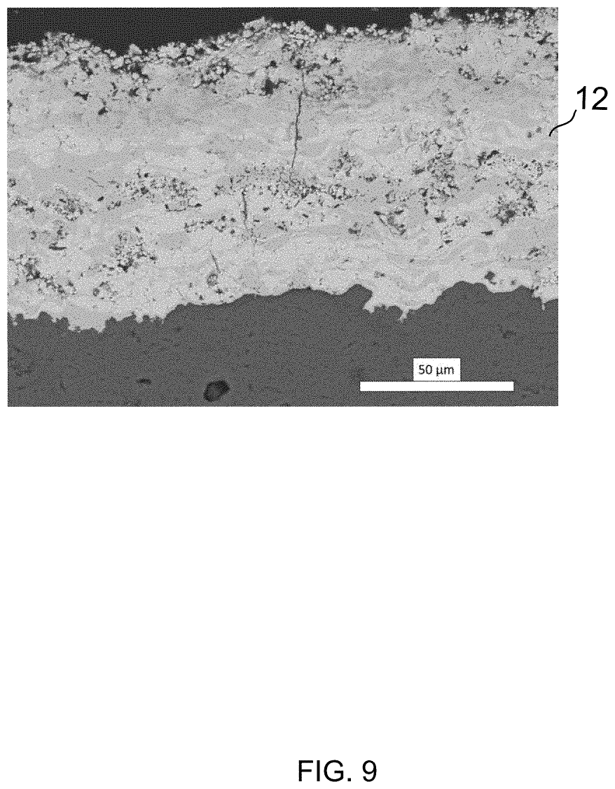

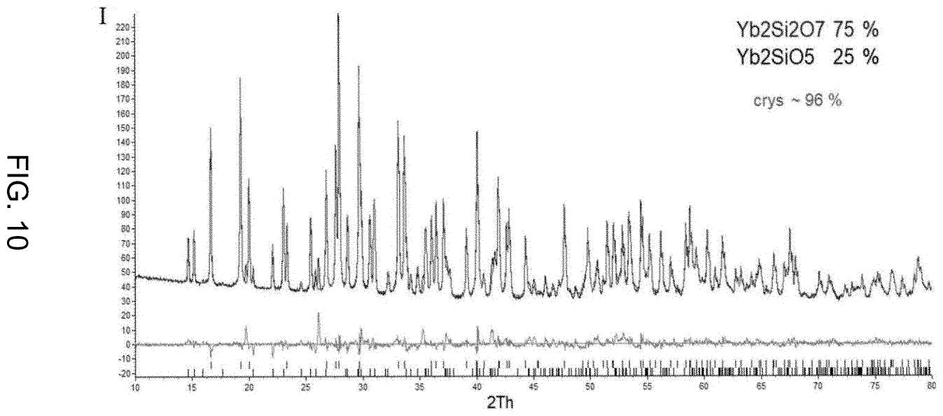

FIG. 9 shows the resulting coating 12 of 75% Yb2Si2O7 and 25% Yb2SiO5 produced on the substrate 1 given by a fiber composite with the silicon bondcoat. The coating 12 has a homogeneous microstructure with high density and low porosity. Only short, unconnected cracks as well as isolated coarse pores appear. An XRD measurement (cf. FIG. 10) shows a degree of crystallinity of 96% after a Rietveld redefinition. As crystalline phases 75% Yb2Si2O7 and 25% Yb2SiO5 were determined.

Example 4:

According to Example 4, a comparatively thick protective coating 12 of at least 100 micrometers is produced by means of a single coating pass.

The spray material 5 used is a rare earth silicate, Yb2Si2O7, in powder form. For example, a spray material 5 can also be used which comprises at least one rare earth hexaaluminate, in particular LaMgAl11O19, or is given by this. The powder 5 has an average particle diameter of less than 50 micrometers, less than 40 micrometers has proven to be particularly suitable. In the present case, this is 30 micrometers. A preferred method of producing the powder 5 is agglomeration and sintering.

Furthermore, an injection distance Ds in the range from 80 mm to 140 mm is selected, in this case 120 mm.

The process gas flow is set to a total flow of at least 100 slpm, in particular at least 150 slpm. In the present case, 174 slpm is selected. A mixture of argon and helium is used as process gas 10. In this case, 170 slpm argon and 4 slpm helium are used.

The current is in the range from 400 A to 500 A, and amounts to 450 A in the present case.

The torch speed is selected to a maximum of 500 mm/s, is 250 mm/s in this case.

The feed rate of the spray material 5 is selected to be at least 50 g/min, is specifically 90 g/min here.

During preheating in step S2, the substrate 1 is brought to a temperature of at least 200° C., in this case to approx. 300° C. The substrate 1 is heated to a temperature of at least 200° C., in this case to approx. 300° C.

During the actual coating process in step S3, the substrate 1 is heated to at least 300° C., in the embodiment example described here to approx. 420° C.

A special feature of this example is that a comparatively thick layer 12 of, for example, 150 micrometers can be produced with a single pass.

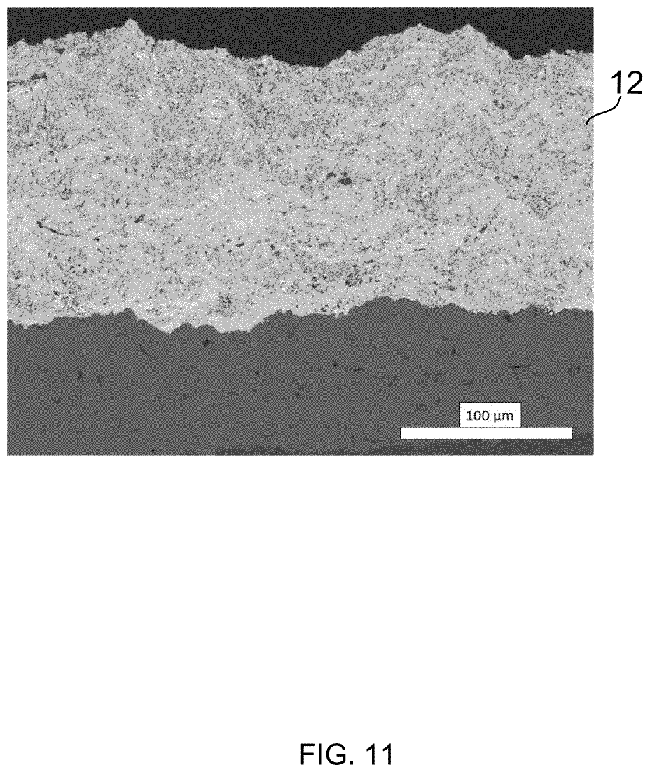

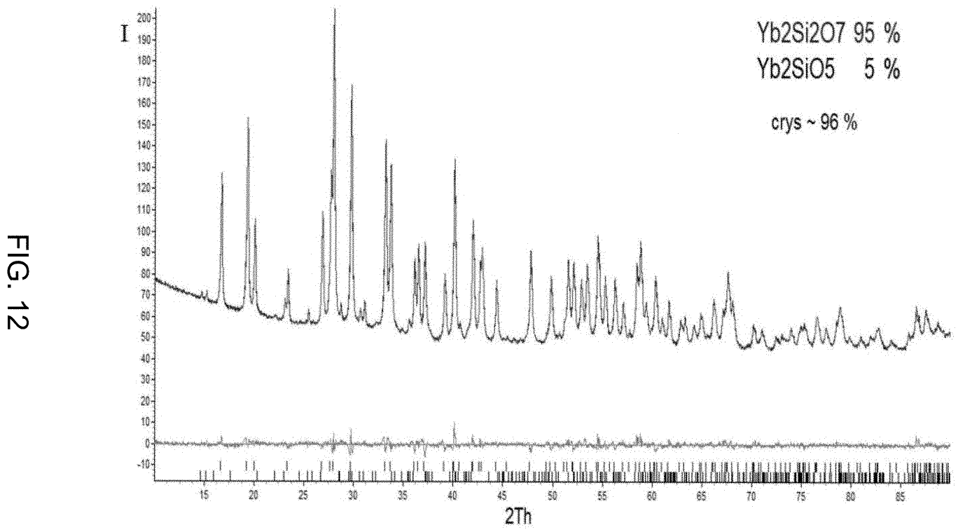

FIG. 11 shows a micrograph of the resulting coating 12 of Yb2Si2O7 produced on the substrate 1 given by a fiber composite with the silicon bondcoat. The coating 12 has a homogeneous microstructure with high density and very fine pores. No cracks occurred. An XRD measurement (cf. FIG. 12) shows a degree of crystallinity of 96% after a Rietveld redefinition. As crystalline phases 95% Yb2Si2O7 and 5% Yb2SiO5 were determined.

Example 5:

According to exemplary embodiment 5, a dense crystalline Y3Al5O12 top layer for a TBC system for protecting a substrate 1 made of a nickel-based material, in particular a nickel-based superalloy, is prepared with an MCrAlY bond coat (M=Ni, Co). Accordingly, as noted above, in the fifth exemplary embodiment, a deviating substrate 1 of corresponding embodiment is provided in step S1.

A further difference is given by the fact that the spray material 5 used is not a rare earth silicate but a rare earth aluminate in powder form, specifically Y3AL5O12 in the example described here. For example, a spray material 5 comprising or given by at least one rare earth hexaaluminate, in particular LaMgAl11O19, can also be used. The powder 5 has an average particle diameter of at most 80 micrometers, at most 30 micrometers has proven to be particularly suitable. In the present case, it is 30 micrometers. A preferred production method of the powder 5 used in the present case is agglomeration and sintering.

Furthermore, an injection distance Ds in the range from 70 mm to 150 mm is selected, in this case 80 mm.

The process gas flow is set to a total flow of at least 40 slpm, in particular at least 50 slpm. In the present case, 56 slpm is selected. A mixture of argon and helium is used as process gas 10. 50 slpm argon and 6 slpm helium are used.

The current is in the range of 350 A to 550 A, and amounts to 470 A in the present case.

The burner speed is selected to be a maximum of 2000 mm/s, and is 250 mm/s in this case.

The feed rate of the spray material 5 is selected to be at least 5 g/min, is specifically 10 g/min here.

During preheating in step S2, the substrate 1 is brought to a temperature of at least 200° C., in this case to approx. 300° C.

During the actual coating process in step S3, the substrate 1 is heated to at least 300° C., in the embodiment example described here to about 600° C.

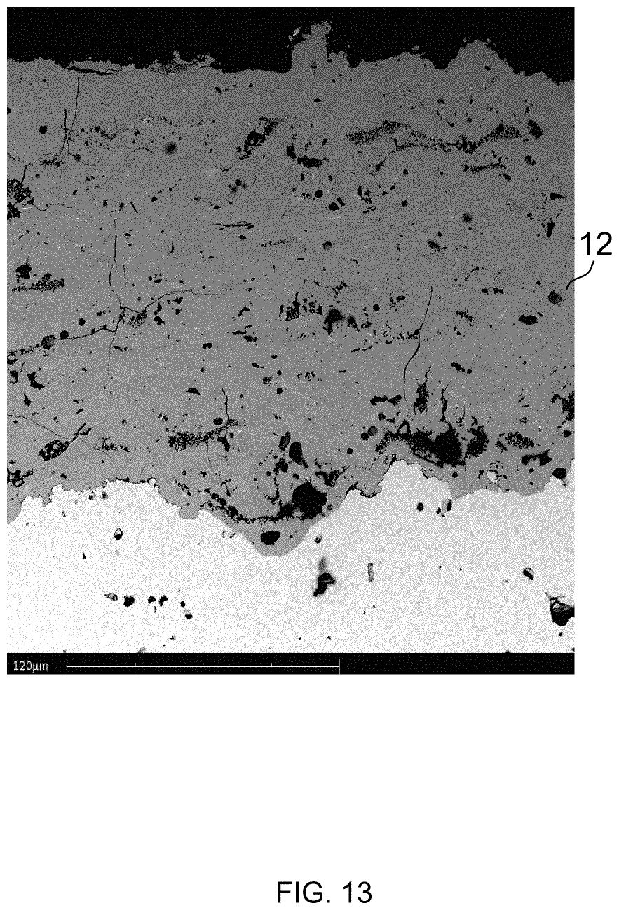

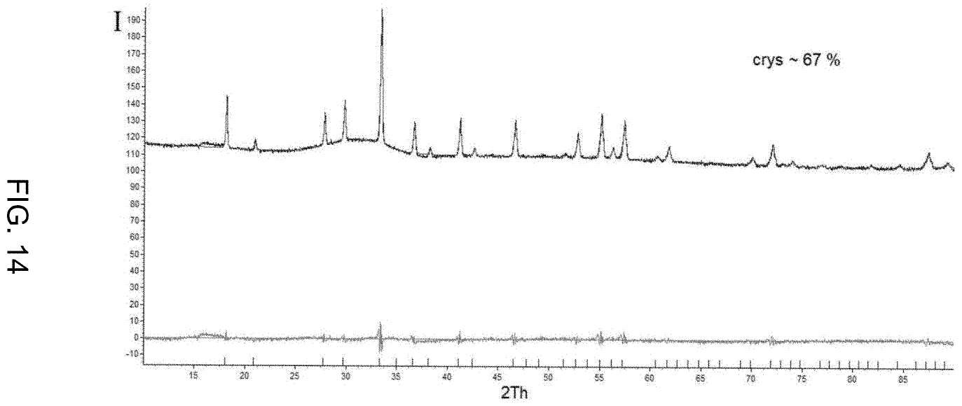

FIG. 13 shows a micrograph of the resulting coating 12 of Y3Al5O12 produced on the substrate 1 from a nickel-based material with a MCrAlY bondcoat (M=Ni,Co). The coating 12 exhibits a homogeneous microstructure with high density and very fine pores. Only short, unconnected cracks occurred. An XRD measurement (cf. FIG. 14) shows a degree of crystallinity of over 60% after Rietveld redefinition.

It should be noted that the coatings 12 obtained according to all five embodiments of the method according to the invention are examples of coatings 12 according to the invention.

1. A method for producing a coating (12) in which
a substrate (1) is provided,
the substrate (1) is provided with a coating (12) by, in particular, atmospheric plasma spraying, wherein a plasma torch (2) with a torch nozzle (3) is used, with which a plasma jet (4) is generated from a supplied process gas (10), and wherein a supplied spraying material (5) is applied to the substrate (1) with the plasma jet (4) in order to obtain the coating (12),
wherein the torch nozzle (3) is characterized by a nozzle diameter (D) or a minimum nozzle diameter (D) in the range from 4 mm to 8 mm, in particular 5 mm to 8 mm, preferably 5 mm to 7 mm, and in that the process gas flow is at least 40 slpm.

2. Method according to claim 1, wherein the process gas flow is at least 50 slpm, in particular at least 60 slpm, preferably at least 70 slpm, particularly preferably at least 100 slpm, very particularly preferably at least 150 slpm.

3. Method according to claim 1, wherein a single-layer or multilayer coating (12) is produced, and/or wherein a particularly semicrystalline silicon or silicate or aluminate layer, hafnate layer or perovskite layer or mixtures thereof is produced as the coating (12) or as part of the coating (12).

4. Method according to claim 1, wherein a spray material (5) is used which comprises or is given by at least one rare earth silicate, preferably Yb2Si2O7, and/or that a spray material (5) is used which comprises or is given by at least one rare earth aluminate, preferably Y3Al5O12 and/or YAlO3 and/or LaM-gAl11O19.

5. Method according to claim 1, wherein a spray material (5) is used which comprises or is given by at least one rare earth hexaaluminate, in particular LaMgAl11O19.

6. Method according to claim 1, wherein a spray material (5) with a mean particle diameter of at most 80 micrometers, in particular at most 50 micrometers, preferably at most 40 micrometers, particularly preferably at most 30 micrometers, is used.

7. Method according to claim 1, wherein a spray material (5) with a mean particle diameter of less than 30 micrometers is used, in particular a spray material (5) with a mean particle diameter in the range from 15 micrometers to 29 micrometers, preferably 10 micrometers to 29 micrometers, particularly preferably 15 micrometers to 29 micrometers.

8. Method according to claim 1, wherein the spray distance (Ds) between the torch nozzle (3) and the substrate (1) is in the range from 60 mm to 200 mm, in particular 70 mm to 180 mm, preferably 80 mm to 140 mm, particularly preferably 100 mm or 120 mm.

9. Method according to claim 1, wherein the current is in the range from 300 A to 550 A, in particular in the range from 300 A to 400 A or 400 A to 500 A, preferably amounts to 375 A or 450 A or 470 A.

10. Method according to claim 1, wherein the burner speed is at most 2000 mm/s, in particular in the range from 100 mm/s to 1500 mm/s, preferably from 200 mm/s to 600 mm/s, especially preferably amounts to 500 mm/s.

11. Method according to claim 1, wherein the feed rate of the spray material (5) is at least 5 g/min, in particular at least 10 g/min, preferably amounts to 10 g/min or 30 g/min or 90 g/min.

12. Method according to claim 1, wherein the substrate (1) is preheated at least in sections to a temperature of at least 200° C. before the application of the coating (12), and/or wherein the substrate (1) is heated at least in sections to a temperature of at least 250° C., preferably at least 300° C., during the application of the coating (12).

13. Method according to claim 1, wherein the substrate (1) comprises silicon, in particular silicon carbide and/or silicon nitride, and/or wherein the substrate (1) comprises nickel, in particular a nickel-based superalloy, and/or the substrate (1) comprises alumina-based composites.

14. Method according to claim 1, wherein the coating (12) is produced in a single pass, preferably wherein a feed rate of the spray material (5) of at least 50 g/min is set.

15. Method according to claim 1,
wherein the process gas flow is at least 100 slpm, preferably in the range from 100 slpm to 500 slpm, particularly preferably in the range from 100 slpm to 400 slpm,
wherein the torch nozzle (3) is characterized by a nozzle diameter (D) or a minimum nozzle diameter (D) in the range from 5 mm to 8 mm, preferably 5 mm to 7 mm, particularly preferably 6 to 7 mm,
and wherein a spray material (5) with a mean particle diameter of at most 40 micrometers is used, in particular a spray material with a mean particle diameter in the range from 5 micrometers to 40 micrometers, preferably in the range from 10 micrometers to 40 micrometers, particularly preferably in the range from 15 micrometers to 40 micrometers,
and wherein the substrate (1) is heated, at least in sections, to a temperature of at least 300° C. during the application of the coating (12), in particular to a temperature in the range from 300° C. to 700° C., preferably in the range from 300° C. to 500° C.

16. Method according to claim 15, wherein the spray distance (Ds) between the torch nozzle (3) and the substrate (1) is at least 100 mm, preferably in the range from 100 mm to 200 mm, and that the current is at least 400 A, preferably in the range from 400 A to 550 A.

17. Component comprising a substrate (1) and a coating (12) obtained by carrying out the method according to claim 1.

18. Method according to claim 2, wherein a single-layer or multilayer coating (12) is produced, and/or wherein a particularly semicrystalline silicon or silicate or aluminate layer, hafnate layer or perovskite layer or mixtures thereof is produced as the coating (12) or as part of the coating (12).

19. Method according to claim 2, wherein a spray material (5) is used which comprises or is given by at least one rare earth silicate, preferably Yb2Si2O7, and/or that a spray material (5) is used which comprises or is given by at least one rare earth aluminate, preferably Y3Al5O12 and/or YAlO3 and/or LaM-gAl11O19.

20. Method according to claim 3, wherein a spray material (5) is used which comprises or is given by at least one rare earth silicate, preferably Yb2Si2O7, and/or that a spray material (5) is used which comprises or is given by at least one rare earth aluminate, preferably Y3Al5O12 and/or YAlO3 and/or LaM-gAl11O19.
